(19) United States
(12) Patent Application Publication
(10) Pub. No.: US 2007/0180324 A1
(43) Pub. Date: Aug. 2, 2007

(54) Apparatus and program for process fault analysis

(75) Inventors: Toshikazu Nakamura, Kawasaki-shi (JP); Shigeru Obayashi, Mishima-shi (JP); Kenichiro Hagiwara, Yokohama-shi (JP); Yoshikazu Aikawa, Tokyo (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 11/638,665

(22) Filed: Dec. 14, 2006

(30) Foreign Application Priority Data
Dec. 15, 2005 (JP) 2005-362156

(51) Int. Cl. G06F 11/00

(52) U.S. Cl. 714/37

(57) ABSTRACT

A process fault analysis apparatus according to the present invention includes a process data editing unit which extracts process features from process data stored in a process data storage unit and stores the process features in a process feature data storage unit, a fault analysis rule data storage unit in which a fault analysis rule for performing fault detection and fault factor analysis from the process features is stored, a fault judgment unit which performs fault detection and fault factor analysis from the process features using the fault analysis rule, and a unit which outputs fault notification information when the fault judgment unit judges that the fault is generated. In the fault factor analysis, a contribution ratio indicating which process feature has how much influence on the fault is determined, and the process feature having the higher contribution ratio is set at the fault factor.

### BACKGROUND OF THE INVENTION

This application claims priority from Japanese patent application 2005-362156, filed on Dec. 15, 2005. The entire content of the aforementioned application is incorporated herein by reference.

1. Field of the Invention

The present invention relates to a process fault analysis apparatus and a program for analyzing a presence or absence of fault and a fault generating factor in a target product processed in association with a process state.

2. Description of the Related Art

In production processes of various products including a semiconductor device and a liquid crystal panel, appropriate management is required to improve a production yield of the product or to maintain the good yield.

The semiconductor device is produced through a semiconductor process having at least 100 processes, and the semiconductor device is produced with plural pieces of complicated semiconductor device production apparatus. Therefore, frequently a relationship between a parameter indicating a status of each production apparatus (process equipment) and characteristics of the semiconductor device produced with each production apparatus is not clearly determined. On the other hand, in the semiconductor process, there is a demand for always strictly managing each process to improve the production yield of the semiconductor device.

For example, Japanese patent Application Laid-Open No. 2004-186445 discloses a modeling apparatus in order to solve the problem. In the modeling apparatus disclosed in Japanese patent Application Laid-Open No. 2004-186445, various pieces of process data generated in performing the process are collected at constant intervals, process features are extracted from the time-series process data, the process feature data and the inspection data are combined for the same product, the combined data is analyzed by data mining, and a model of correlation between the process feature and result data is produced in the semiconductor device production process. According to the model, it can be predicted that the fault is generated when the process feature become which condition, and fault generation point and cause can also be estimated.

In the modeling apparatus disclosed in Japanese patent Application Laid-Open No. 2004-186445, the fault generation can be estimated such that “Careful, product having lightly faulty film is being produced” and “Product having heavily faulty film is being produced. Stop apparatus.”, and the specific fault generation point can specifically be estimated or the fault result can be displayed as a fault message such that “There is a risk of generating breakdown in pump A. Stop forcedly apparatus.” Therefore, useful information can be provided to an operator who operates the process equipment or a worker who performs maintenance.

However, in the modeling apparatus disclosed in Japanese patent Application Laid-Open No. 2004-186445, the fault generation point is estimated with a model in which the correlation between the fault point and the process feature is uniquely specified. Therefore, when the fault cause cannot be identified, it is necessary for the worker who performs the maintenance to check the fault cause from scratch, the work becomes troublesome and a long time is required.

In view of the foregoing, an object of the invention is to provide an apparatus and a program for process fault analysis, in which the fault cause candidate can be determined when the fault is detected.

### SUMMARY OF THE INVENTION

A process fault analysis apparatus of the present invention in which, in a production system including at least one production apparatus, process data obtained in performing a process is collected at predetermined intervals and a process fault is detected in each unit target product to analyze a fault factor based on the obtained time-series process data, the process fault analysis apparatus includes a process data storage unit in which the time-series process data is stored; a process data editing unit which extracts process features from the process data stored in the process data storage unit; a fault analysis rule data storage unit in which a fault analysis rule is stored, the fault analysis rule being used to perform fault detection and fault factor analysis from the process features; a fault judgment unit which performs the fault detection and fault factor analysis from the process features using the fault analysis rule; and a unit which outputs fault notification information when the fault judgment unit judges that the fault is generated, wherein, in the fault factor analysis, a contribution ratio indicating which process feature has how much effect on the fault is determined, and the process feature having the higher contribution ratio is set at a fault factor.

At this point, “process” includes a production process. The target product produced by the production process includes a semiconductor device and FPD (Flat Panel Display: display in which liquid crystal, PDP, EL, FED, or the like is used). “Unit target product” may be grasped by a usual counting unit such as one semiconductor wafer and one glass substrate, by a product group unit such as one lot of the products, or by a unit of a part of the product such as a region set on the large-size glass substrate. The output process of the fault notification information includes various processes such as the output on the display device, notification through an e-mail transmission, and storage in the storage device.

According to the invention, when the fault judgment is made, the process feature having the higher contribution ratio with respect to the judgment result is extracted as the fault factor, it is easily understood which piece of process data causes the fault judgment in generating the fault, and thereby the fault generation point is easily identified in the process equipment.

Further, in the process fault analysis apparatus of the invention, in the fault detection, it is judged that the fault is generated when a y value determined from the following regression expression by a PLS method exceeds a threshold;
y=b0+b1·x1+b2·x2+ . . . +b(n−1)·x(n−1)+bn·xn
where x1, x2, . . . , and xn are variables of the process feature and b0, b1, b2, . . . , and bn are coefficients (b1, b2, . . . , and bn are weight of each variable), and the contribution ratio of the fault factor analysis is set at a value in which a difference between an average value and a measured value multiplied by the coefficient shown below;
b1·(x1−X1), b2·(x2−X2), . . . , and bn·(xn−Xn)
where X1, X2, . . . , and Xn are average values of each variable.

Further, in the process fault analysis apparatus of the invention, a fault factor data storage unit in which only fault factor data is stored is further included. Further, in the process fault analysis apparatus of the invention, the fault notification information includes the fault factor data and an ID code for identifying unit target product. Further, in the process fault analysis apparatus of the invention, the fault notification information includes a predetermined number of contribution ratios in the descending order of the contribution ratio.

A program of the present invention for causing a computer to function as a process data editing unit which extracts process features from time-series process data which is obtained by collecting the process data, obtained in performing a process, at predetermined interval; a fault judgment unit which performs fault detection and fault factor analysis from the process features using a fault analysis rule, the fault analysis rule being stored in a fault analysis rule data storage unit; and a unit which outputs fault notification information when the fault judgment unit judges that the fault is generated, wherein, in the fault factor analysis performed by the fault judgment unit, a contribution ratio indicating which process feature has how much effect on the fault is determined, and the process feature having the higher contribution ratio is determined as a fault factor.

In a computer-readable storage medium of the present invention, the program of the invention is stored.

According to the invention, the fault cause candidate can be determined by extracting the fault factor based on the contribution ratio, when the fault is detected.

### BRIEF DESCRIPTION OF THE DRAWINGS

FIG. 1 shows a production system including a process fault analysis apparatus according to a first embodiment of the invention;

FIG. 2 shows an internal structure of the process fault analysis apparatus;

FIG. 3 shows a data structure of various kinds of data processed by the process fault analysis apparatus;

FIG. 4 shows a data structure of rule data stored in a fault analysis rule data storage unit;

FIG. 5 shows a specific example of the rule data stored in the fault analysis rule data storage unit;

FIG. 6 shows a flowchart explaining a function of a fault analysis rule editing unit;

FIG. 7 shows a flowchart explaining a function of a fault judgment unit;

FIG. 8 shows an example of information displayed on a fault display apparatus;

FIG. 9 shows another example of information displayed on the fault display apparatus;

FIG. 10 shows another example of information displayed on the fault display apparatus;

FIG. 11 shows a modification;

FIG. 12 shows a production system including a process fault analysis apparatus according to a second embodiment of the invention;

FIG. 13 shows a data structure of data stored in a fault factor data storage unit; and

FIG. 14 shows a flowchart explaining a function of a fault judgment unit.

### DETAILED DESCRIPTION OF THE PREFERRED EMBODIMENTS

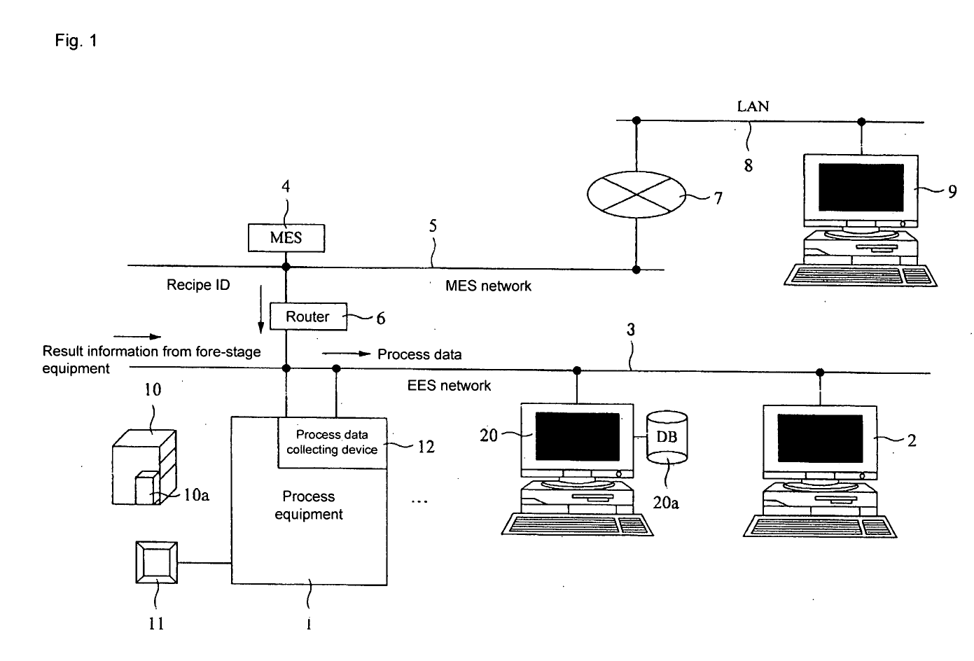

FIG. 1 shows a production system including a process fault analysis apparatus according to a first embodiment of the invention. The production system includes a process equipment 1, a process fault analysis apparatus 20, and a first fault display apparatus 2. These pieces of apparatus are connected to one another by an EES (Equipment Engineering System) network 3 which is of an apparatus network for exchanging process-related information more specific than production management information at high speed. Although not shown in FIG. 1, other pieces of apparatus used in fore-stages of the process equipment 1, other pieces of apparatus used in subsequent stages of the process equipment 1, and an inspection apparatus are also connected to the EES network 3. The production system also includes a production management system 4 and an MES network 5. The production management system 4 includes MES (Manufacturing Execution System). The MES network 5 is connected to the production management system 4, and the production management information is transmitted through the MES network 5. The EES network 3 and the MES network 5 are connected to each other through a router 6. The production management system 4 located on the MES network 5 can make an access to each apparatus on the EES network 3 through the router 6. The MES network 5 is connected to another network 8 through a line 7 such as an intranet and the Internet. A second fault display apparatus 9 is also connected to the network 8.

For example, the production system is used to produce a semiconductor device or a liquid crystal panel, and the process equipment 1 performs a process (such as a process of depositing a film on a wafer) for producing the semiconductor device or the liquid crystal panel.

In the semiconductor device production process or the liquid crystal panel production system, the predetermined number of wafers or glass substrates (hereinafter referred to as “wafer”) to be processed is set in a cassette 10, and the process equipment 1 performs the predetermined process to the wafers while the wafers are moved in a unit of cassette. Although only one process equipment 1 is shown in FIG. 1, because predetermined processes are performed by the plural pieces of process equipment, the movement of the wafers between the pieces of apparatus is performed in a unit of cassette. The predetermined number of wafers mounted on the cassette 10 becomes the same lot.

In the semiconductor device production system of the first embodiment, because it is necessary to manage the individual wafer, a product ID is imparted to individual wafer. For example, the product ID can be set by combining a lot ID and an identification number in the lot. That is, when the number of wafers settable in the lot is lower than ten while the lot ID is “0408251”, the product ID of the second wafer (identification number is “2” in the lot) in the lot can be set to “04082512” in which the identification number in the lot is added to the last one digit. The product ID can be set by a process data collecting device 12 incorporated into the process equipment 2.

Alternatively, the product ID is recorded in the tag 10a in place of the lot ID, or the product ID concerning all the wafers stored along with the lot ID is stored in the tag 10a, and the process equipment 1 (process data collecting device 12) may obtain all the product IDs stored in the tag 10a. In the case where only one wafer is set in the cassette 10, ID recorded in the tag 10a can directly be used as the product ID. In performing the analysis in lot unit, it is not necessary to obtain the product ID or to produce the product ID based on the lot ID.

The RF-ID (radio frequency identification) tag 10a is attached to the cassette 10. The tag 10a is electromagnetically coupled to an RF-ID read and write head 11 joined to the process equipment 2, and any data is read and written in the tag 10a in non-contact manner. The tag 10a is also called data carrier. The lot ID (lot ID is the basis for the product ID or the product ID of itself) and information such as delivery time from the fore-stage apparatus are stored in the tag 10a.

The process equipment 1 obtains a recipe ID transmitted from the production management system 4 through the MES network 5 and the router 6. The process equipment 1 has a corresponding table between the recipe ID and the actually performed process, and the process equipment 1 performs the process according to the obtained recipe ID.

The process data collecting device 12 is incorporated into the process equipment 1. The process data collecting device 12 collects process data in time series during standby state of the process equipment 1 or during a period in which the process equipment 1 performs the process. The process data is information on status of the process equipment 1. Examples of the process data include voltage and current in operating the process equipment 1 and a residence time between the delivery from the fore-stage process equipment and the input to the process equipment 1. In the case where the process equipment 1 includes a plasma chamber to perform a deposition process to the wafer, examples of the process data include pressure in the plasma chamber, a flow rate of gas supplied to the plasma chamber, a wafer temperature, and plasma light quantity. The process equipment 1 includes detection devices for detecting the pieces of process data, and the outputs of the detection devices are imparted to the process data collecting device 12.

The process data collecting device 12 collects the delivery time from the fore-stage apparatus, read from the tag 10a, and the input time to the process equipment 1 in which the wafers are currently set. The residence time from the fore-stage apparatus can be computed by determining a difference between the delivery time and the input time. The RF-ID read and write head 11 writes the delivery time and the like to the tag 10a when the wafers are delivered from the process equipment 1, if needed.

The process data collecting device 12 has a communication function. The process data collecting device 12 collects any process data generated in the process equipment 1, and the process data collecting device 12 outputs the collected process data to the EES system network 3 while the process data corresponds to the product ID. The kind of the collected process data is not limited to the above examples, but other pieces of process data may further be obtained.

The process fault analysis apparatus 20 obtains the process data with product ID outputted from the process data collecting device 12 through the EES network 3, and the process data with product ID is stored in a database 20a while the pieces of process data are associated with one another based on the product ID.

Form the viewpoint of hardware, the process fault analysis apparatus 20 is a general personal computer, and each function of the process fault analysis apparatus 20 is realized by an application program running on an operating system such as Windows (registered trademark). A model producing device utilizes the database. The database can be provided in a storage device such as an external hard disk drive and a hard disk drive built in the computer constituting the process fault analysis apparatus 20, or the database can be provided in another computer which conducts the communication with the process fault analysis apparatus 20.

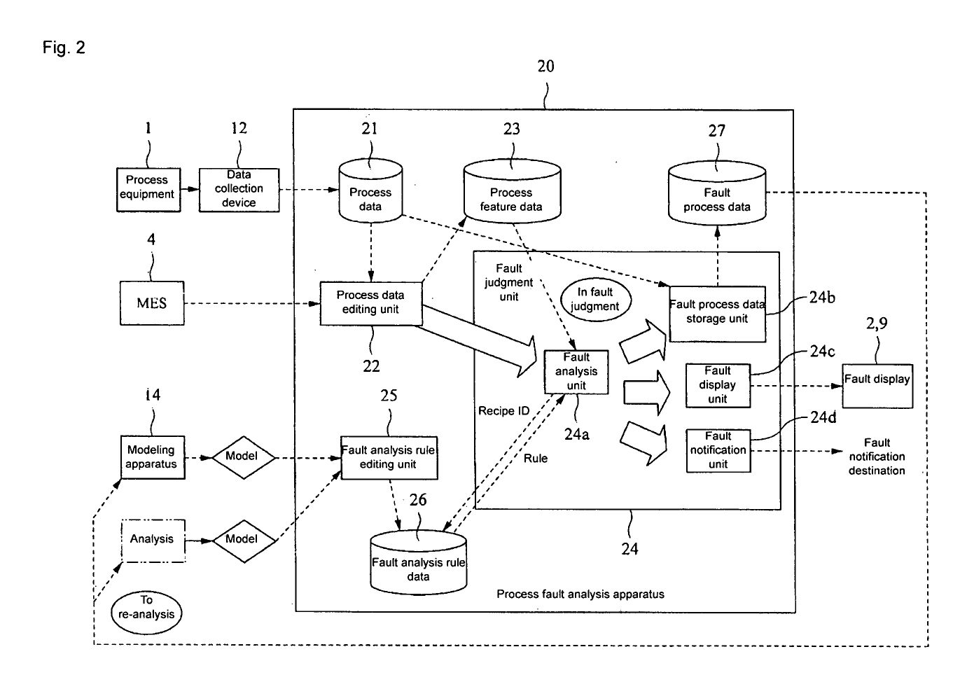

FIG. 2 shows an internal structure of the process fault analysis apparatus 20. The process fault analysis apparatus 20 includes a process data storage unit 21, a process data editing unit 22, a process feature data storage unit 23, a fault judgment unit 24, a fault process data storage unit 27, a fault analysis rule data storage unit 26, and a fault analysis rule editing unit 25. The process data transmitted from the process data collecting device 12 is stored in the process data storage unit 21. The process data editing unit 22 computes process features from various kinds of process data stored in the process data storage unit 21. The process features computed by the process data editing unit 22 are stored in the process feature data storage unit 23. The fault judgment unit 24 judges whether or not the fault exists based on the process features stored in the process feature data storage unit 23. The process data for the wafer in which the fault judgment unit 24 judges that the fault exists is stored in the fault process data storage unit 27. A fault analysis rule used to perform a judgment process with the fault judgment unit 24 is stored in the fault analysis rule data storage unit 26. The fault analysis rule editing unit 25 accesses the fault analysis rule data storage unit 26 to make an addition to or a change of the fault analysis rule. Each storage unit can be provided in the external storage device (database 20a) of the process fault analysis apparatus 20 or in the internal storage device.

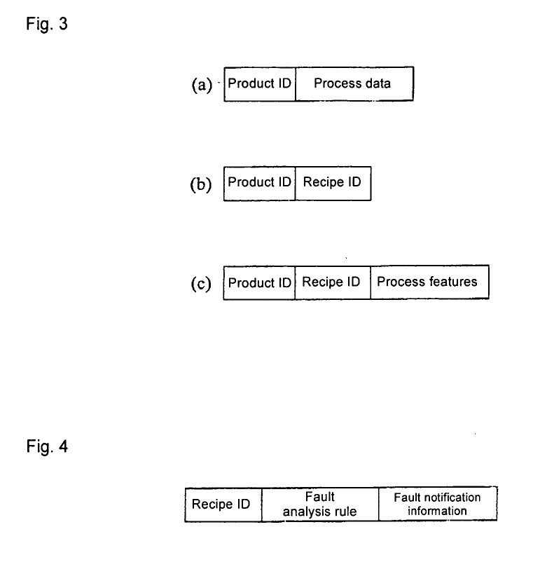

As shown in FIG. 3A, the process data stored in the process data storage unit 21 is associated with the product ID. The process data includes information on date and time in which the process data is collected in addition to various kinds of process data collected by the process data collecting device 12. The process data is stored in the process data storage unit 21in each product ID according to the date and time information.

The process data storage unit 21 includes a tentative storage unit such as a ring buffer. In the process data storage unit 21, the process data is deleted at predetermined timing after the process is ended.

The process data editing unit 22 calls the process data stored in the process data storage unit 21 in time series, and the process data editing unit 22 computes the process features in each wafer. Examples of the process features include peak values, a summation, and an average value of the pieces of process data for the same product ID, which are computed from the process data. The process features also includes time in which a process data value exceeds a setting threshold.

The process data editing unit 22 obtains the recipe ID outputted from the production management system 4 along with the product ID. A recipe is a set of a command, a setting, and a parameter for a predetermined process equipment. There are plural recipes according to the processing target, the process, and the apparatus, and the recipes are managed by the production management system 4. The recipe ID is imparted to each recipe. The recipe for the wafer processed by the process equipment 1 is specified by the product ID and the recipe ID.

The process data editing unit 22 obtains a set of the product ID and the recipe ID of FIG. 3B in the following manner. The process data editing unit 22 accesses the production management system (MES) 4 to search the corresponding recipe ID by the product ID of the analysis target wafer and an apparatus ID for specifying the process equipment 1. Then, the process data editing unit 22 directly obtains the searched recipe ID from the production management system 4, or the process data editing unit 22 obtains the searched recipe ID from the production management system 4 through the process data collecting device 12. Alternatively, in the case where the process data editing unit 22 obtains the searched recipe ID through the process data collecting device 12, the process data collecting device 12 obtains the recipe ID of the ongoing process from the production management system (MES) 4, and the process data collecting device 12 may transfer the recipe ID in conjunction with the process data of the process equipment 1 to the process fault analysis apparatus 20.

The process data editing unit 22 combines the computed process feature data and the obtained recipe ID by the product ID, and the combined data is stored in the process feature data storage unit 23. Therefore, the process feature data storage unit 23 has the data structure shown in FIG. 3C.

The fault analysis rule editing unit 25 obtains a model obtained by the modeling apparatus 14 or manual analysis, and the fault analysis rule editing unit 25 defines a fault analysis rule and stores the fault analysis rule in the fault analysis rule data storage unit 26. For example, the modeling apparatus, disclosed in Japanese Patent Application Laid-Open No. 2004-186445, in which data mining is utilized can be used as the modeling apparatus 14. As used herein, the data mining shall mean a technique of extracting a rule or a pattern from the large-scale database. A technique called decision tree analysis and a technique called regression tree analysis are well known as a specific technique of the data mining.

The fault analysis rule editing unit 25 also registers fault notification information corresponding to the fault analysis rule. Therefore, as shown in FIG. 4, the data structure of the fault analysis rule data storage unit 26 becomes a table structure in which the recipe ID, the fault analysis rule, and the fault notification information are associated with one another.

The fault notification information includes specific notification contents and information for specifying the pieces of fault display apparatus 2 and 9 displaying the judgment result based on the fault analysis rule, a notified party notified of the decision result, and the like. For example, the notified party includes an e-mail address of a person in charge. Both the pieces of fault display apparatus 2 and 9 and the notified party may be registered as the notified party, and either the pieces of fault display apparatus 2 and 9 or the notified party may be registered as the notified party. For example, the notified parties are classified by a degree of fault or a fault point, which is determined by the judgment, and the notified parties can be sorted according to the classification. The plural pieces of fault display apparatus, notified parties, and notification contents can be specified for one classification. In the system configuration shown in FIG. 1, the fault display apparatus includes the fault display apparatus 2, which is connected to the EES network 3 and placed on the site of the production line in which the process equipment 1 is installed, and the fault display apparatus 9 placed in a remote place. Therefore, the fault display apparatus which becomes the notified party is sorted according to the kind of the fault. Techniques such as a linear regression analysis, a decision tree analysis, a Mahalanobis distance principal component analysis, a moving principal component analysis, and DISSIM can be used as the fault analysis rule.

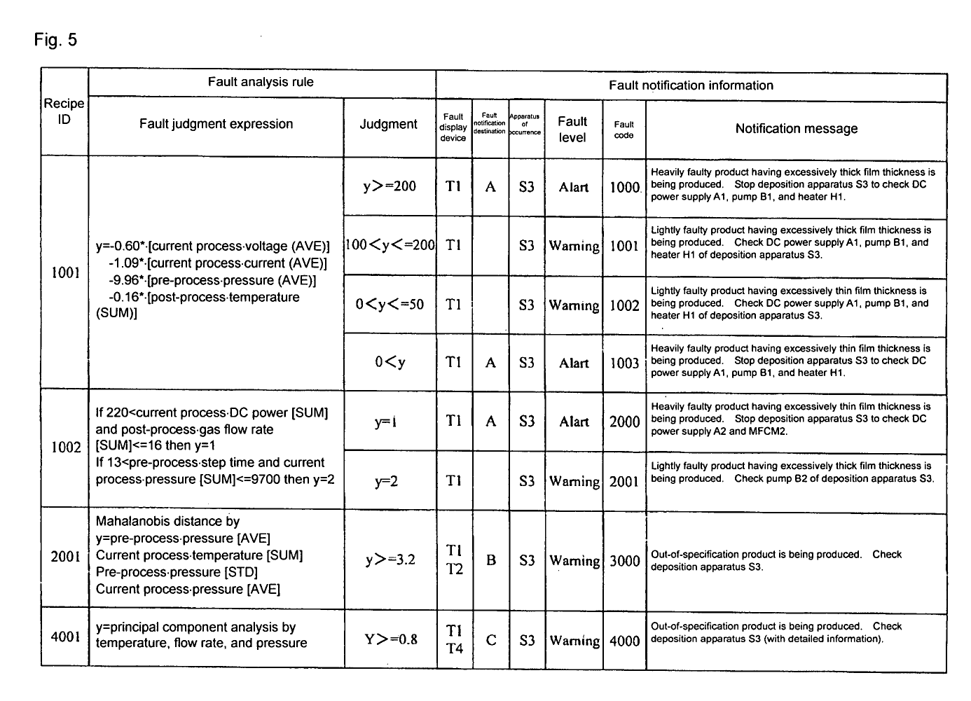

FIG. 5 shows a specific example of the data (recipe ID, fault analysis rule, and fault notification information) stored in the fault analysis rule data storage unit 26. As shown in FIG. 5, the fault analysis rule includes a judgment expression in which a computation process is performed based on the process features and a criterion for determining whether or not the fault is generated in a value (y) determined from the judgment expression.

The fault analysis rule is used to perform the fault detection or fault factor analysis from the process features. The fault detection is used to judge whether or not the fault exists. In the example shown in FIG. 5, the recipe IDs=1001, 1002, and 2001 correspond to the fault analysis rules for detecting the anomalies respectively. In the recipe IDs, the fault point can specifically be identified. The recipe ID=4001 also corresponds to the fault analysis rule for detecting the fault. However, in the fault analysis rule corresponding to the recipe ID=4001, the fault point cannot be identified because the judgment is comprehensively made from the plural fault factors.

The fault factor analysis is used to determine fault factor data. The fault factor data includes both a name indicating the process data or process data features and contribution ratio data. The contribution ratio data indicates which process data or which feature of the process data has how much influence on the fault. As the numerical value of the contribution ratio data is increased, the influence of the process data or process data features on the fault is increased, namely, the process data or process data features can be said to be the factor providing the fault. The fault factor data is extracted while including the top N pieces (for example, five pieces) of contribution ratio data in the pieces of contribution ratio data computed from the fault factor analysis. On the basis of the extracted fault factor data, an operator understands which piece of process data is checked when the fault is detected.

In the first embodiment, the contribution ratio for determining the fault factor data is determined from a regression expression obtained by a PLS (Partial Least Squares) method. The regression expression obtained by the PLS method is shown as follows.
y=b0+b1·x1+b2·x2+ . . . +b(n−1)·x(n−1)+bn·xn

Where x1, x2, . . . , and xn are a process feature and b0, b1, b2, . . . , and b1, b2, . . . bn are a coefficient, and b1, b2, . . . and bn are a weight of each process feature. It is judged that the y value determined by the regression expression is anomalous when the y value exceeds a threshold. For example, the fault detection by PLS method is disclosed in paragraph numbers [0080] to [0093] of Japanese patent Application Laid-Open No. 2004-349419.

In the first embodiment, the contribution ratio of each process feature is determined by utilizing the PLS method. It is assumed that Y is a PLS predictive value when each variable (x1, x2, . . . and xn) indicates an average value. Then, it is evaluated how much each term contributes to magnitude of y−Y which is of a difference between the PLS predictive value and the y value determined by substituting the actually obtained process feature into each variable. That is, assuming that X1, X2, . . . and Xn are the average value of each variable, the value of each term in the above expression is obtained as follows.
b1·(x1−X1), b2·(x2−X2), . . . , and bn·(xn−Xn)

Thus, the value of each term determined by multiplying the difference between the average value and the measured value by the coefficient is used as the contribution ratio data of each process feature.

The recipe ID=4001 of FIG. 5 corresponds to the factor analysis in which the contribution ratio is used. In the fault analysis rule of the recipe ID=4001, the plural fault factor can be listed although the fault point cannot be identified. Temperature, flow Rate, and pressure are the process features determined from a temperature, a gas flow rate, and a gas pressure respectively.

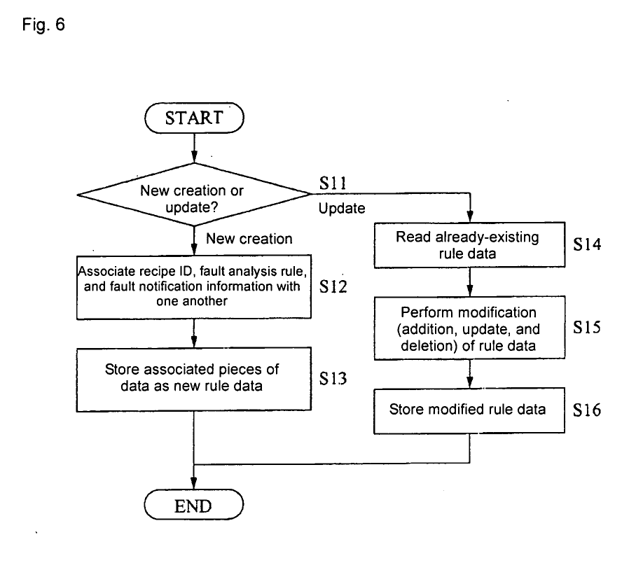

The specific processing function of the fault analysis rule editing unit 25 performs a flowchart shown in FIG. 6. The fault analysis rule editing unit 25 judges whether the input is a new creation process or an update process (S11). For example, the judgment is made by the fault analysis rule editing unit 25 as follows. The fault analysis rule editing unit 25 causes the display device of the personal computer to display an input screen including a “new creation process” button and an “update process” button, and the fault analysis rule editing unit 25 recognizes that one of the buttons is selected.

When the input is the new creation process, the fault analysis rule editing unit 25 associates the recipe ID, the fault analysis rule, and the fault notification information with one another (S12). Specifically, the fault analysis rule editing unit 25 obtains the recipe ID, the model, and the fault notification information which are imparted from the modeling apparatus 14, which allows the association to be established. The fault analysis rule is identified from the model. In the case where an unregistered item exists in the fault notification information imparted from the model producing device, the fault analysis rule editing unit 25 displays the obtained information on the display device. It is assumed that the table format shown in FIG. 5 is used as the display mode in which the pieces of information are displayed on the display device, and the unregistered item remains in blank. A user operates an input device of the personal computer constituting the process fault analysis apparatus 20 to input the unregistered item. The fault analysis rule editing unit 25 associates the information on the unregistered item with the information obtained from the modeling apparatus 14. Examples of the unregistered item include the fault notified party and information for identifying the fault display apparatus on which the fault information is displayed. The unregistered item can be set on the user side. Obviously the modeling apparatus may produce all the items of the fault notification information. The model produced by the modeling apparatus 14 may be imparted on line to the fault analysis rule editing unit 25, and the model may be imparted off line such that the operator inputs the model.

The fault analysis rule editing unit 25 stores the associated pieces of data performed by process step S12 in the fault analysis rule data storage unit 26 in the form of new rule data, and the new creation process is ended (S13).

When the input is the update process, since the branch decision in the process step S11 is judged as “No” the fault analysis rule editing unit 25 accesses the fault analysis rule data storage unit 26 to read the already-existing rule data (S14). In the case where the recipe ID of the editing target is known, the corresponding rule data can be read by searching the rule data with the recipe ID, and all the pieces of data can also be read. In the case where all the pieces of data are be read, the fault analysis rule editing unit 25 outputs all the pieces of data to the display device in the table form shown in FIG. 5.

Then, the fault analysis rule editing unit 25 performs modification (such as addition, update, and deletion) of the read rule data (Sl5). The modified rule data is stored in the fault analysis rule data storage unit 26 (S16), and the update process is ended.

The fault judgment unit 24 includes a fault analysis unit 24a, a fault process data storage unit 24b, a fault display unit 24c, and a fault notification unit 24d. The fault analysis unit 24a makes fault judgment according to the process features read from the process feature data storage unit 23 using the fault analysis rule stored in the fault analysis rule data storage unit 26. The fault judgment made by the fault analysis unit 24a includes both the existence of the fault and the fault factor analysis.

When the fault is detected by the fault analysis unit 24a, the fault process data storage unit 24b reads the process data for the wafer in which the fault is detected by the fault analysis unit 24a, and the process data is stored as the fault process data in the fault process data storage unit 25. At this point, the registration may be made while the fault judgment result (y value) is associated.

When the fault is detected by the fault analysis unit 24a, the fault display unit 24c outputs a fault message to the specified fault display apparatus. The outputted fault message is stored in the fault analysis rule data storage unit 26. In the case where the fault factor analysis is performed, the detail pieces of data such as the contribution ratio are simultaneously outputted.

When the fault is detected by the fault analysis unit 24a, the fault notification unit 24d outputs a fault message to the specified fault notified party by the specified method. For example, the fault notification unit 24d transmits an e-mail to the specified address. The outputted fault message is stored in the fault analysis rule data storage unit 26. In the case where the fault factor analysis is performed, the detail pieces of data such as the contribution ratio are simultaneously outputted.

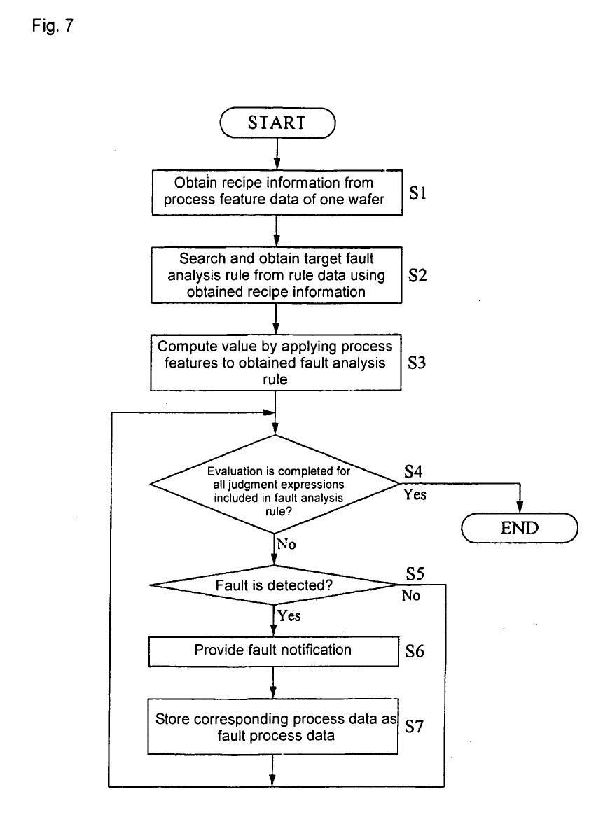

The specific processing function of the fault judgment unit 24 performs a flowchart shown in FIG. 7. The fault analysis unit 24a accesses the process feature data storage unit 23, and the fault analysis unit 24a obtains the recipe information on the process feature data by extracting the process feature data of the one wafer with the one product ID (S1).

The fault analysis unit 24a accesses the fault analysis rule data storage unit 26 to obtain the fault analysis rule corresponding to the obtained recipe information (S2). The fault analysis unit 24a computes the y value by substituting the process features into the fault judgment expression of the obtained fault analysis rule (S3).

The fault analysis unit 24a judges whether or not the evaluation is completed for all the judgment expressions included in the fault analysis rule (S4). The fault analysis unit 24a judges whether or not the judgment, whether or not the y value is matched with the criterion of the fault detection rule, is made for all the y values determined in Step S3. When an unevaluated criterion exists in Step S4, the fault analysis unit 24a judges whether or not the fault exists based on the unevaluated criterion (S5). For example, because the four criteria exist in the recipe ID=1001, when the y value is computed from the fault judgment expression by performing Step S3, the fault analysis unit 24a sequentially checks which criterion is matched with the y value. In the case of the recipe ID=4001, the fault analysis unit 24a performs the principal component analysis. When the y value is not lower than the criterion of 0.8, the fault analysis unit 24a simultaneously confirms the contribution ratio data included in each fault factor data, and the fault analysis unit 24a extracts the pieces of fault factor data corresponding to the top N values of the pieces of contribution ratio data. Any N value can be set. For example, the N value may be set to five, or the N value may be set such that all the pieces of fault factor data are extracted (N=n). When the fault is detected (Yes in S5), the fault notification is provided according to the fault notification information corresponding to the criterion. Specifically, the fault display unit 24c outputs the message to the predetermined pieces of fault display apparatus 2 and 9, and the fault notification unit 24d notifies the predetermined fault notified party of the fault by the e-mail transmission. The information on the date of occurrence and the fault notification ID are added to the notified contents in addition to the fault display information stored in the fault analysis rule data storage unit 26 and the recipe ID.

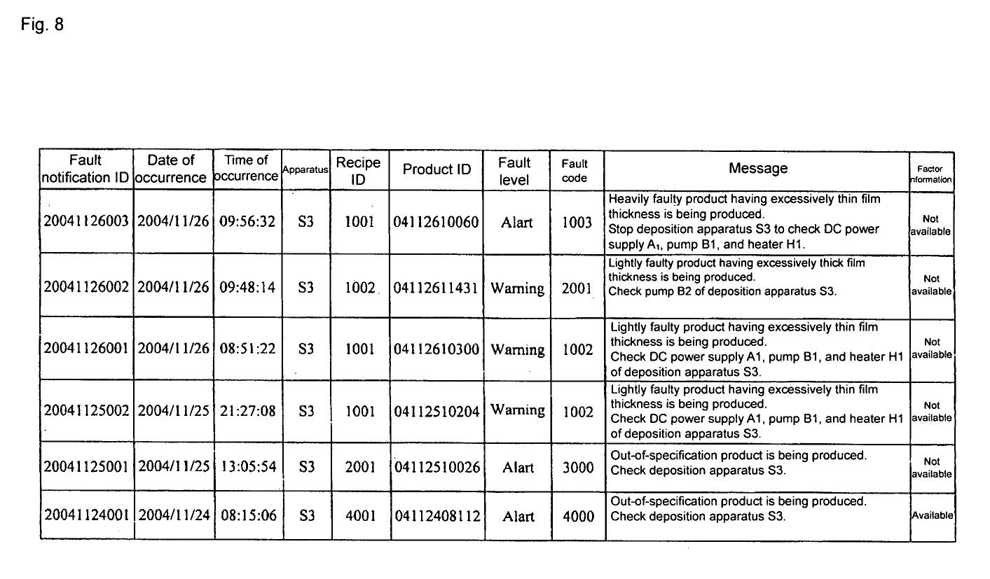

The table format shown in FIG. 8 is used as the display mode in which the pieces of information are displayed on the display devices of the pieces of fault display apparatus 2 and 9 based on the fault notification outputted from the fault display unit 24c. FIG. 8 shows an example of a list of the plural pieces of fault notification. However, because the actually the fault notification is transmitted in real time from the fault display unit 24c, actually the transmitted information is displayed while sequentially added to the list. Obviously the pieces of fault display apparatus 2 and 9 can store the transmitted fault notification information and the like in the storage device and display the list later. Alternatively, although not shown in the drawing, contents outputted from the fault display unit 24c or fault notification unit 24d may be stored and managed in the database provided in the process fault analysis apparatus 20.

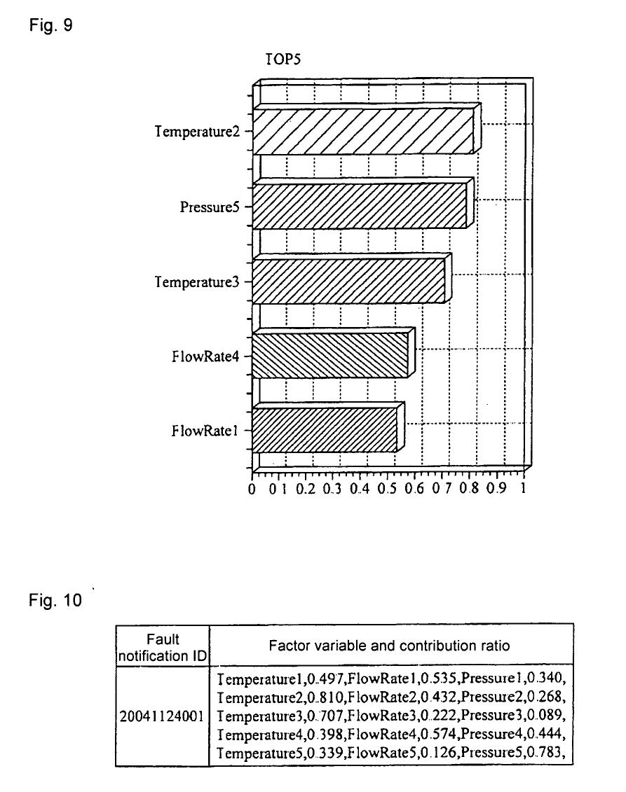

As shown in FIG. 8, the pieces of information outputted from the fault display unit 24c include the information on the presence or absence of the fault factor. In FIG. 8, both the factor variable and the contribution ratio are outputted when the factor information exists like the fault notification ID=20041124001. As shown in FIG. 9, the pieces of fault display apparatus 2 and 9 display the top N pieces (five pieces in this case) of data by a bar graph based on the obtained factor variable and contribution ratio. Therefore, the user can understand at a glance which factor variable, i.e. which process feature possibly causes the fault generation. The display mode of the factor variable and contribution ratio is not limited to the bar graph, but various display modes can be adopted. For example, the factor variable and contribution ratio may be displayed by a circle graph or other graphs, and the factor variable and contribution ratio may be text-displayed in the table form as shown in FIG. 10. The fault process data storage unit 24b accesses the process data storage unit 21 by the product ID in which the fault analysis unit 24a judges that fault is generated. The fault process data storage unit 24b obtains the corresponding process data, and the obtained process data is stored as the fault process data in the fault process data storage unit 27 (S7).

The fault process data obtained in the fault process data storage unit 27 is read to and analyzed by the modeling apparatus 14, and the fault process data is used as the information for generating the new model or modifying the already-existing model. The analysis is not limited to the automatic analysis performed by the modeling apparatus 14, but man may perform the analysis to produce the new model. The model produced by the re-analysis is stored in the fault analysis rule data storage unit 26 through the fault analysis rule editing unit 25, and the model is used for the subsequent fault judgment.

Thus, because the process data for the wafer in which the fault judgment unit judges that the fault is generated can be stored as the fault process data in the fault process data storage unit 27, only the process data in the fault is stored from the huge amount of raw process data, and the capacity can be saved in the physical storage device such as the hard disk drive.

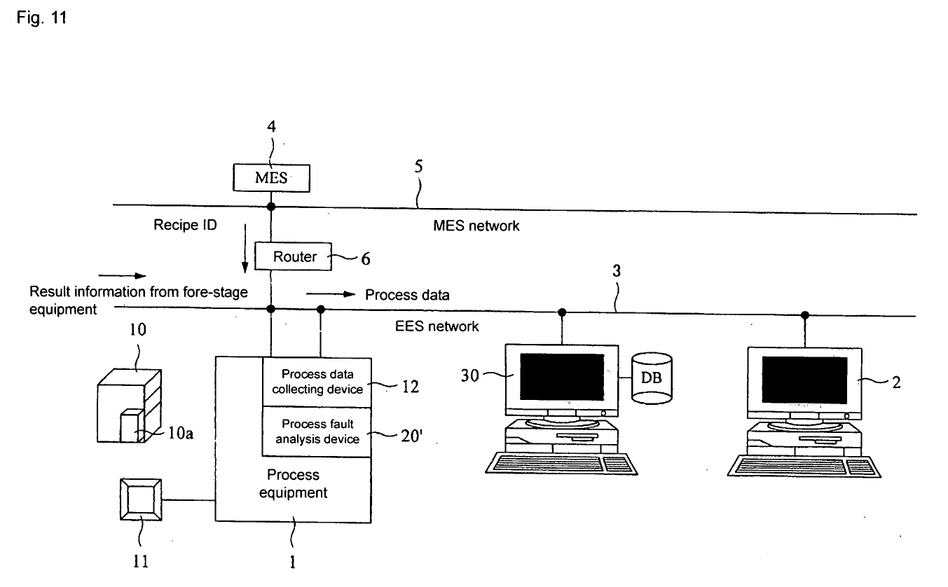

FIG. 11 shows a modification of the first embodiment. In the modification, a process fault analysis apparatus 20′ is mounted in the process equipment 1. The process fault analysis apparatus 20′ basically has the same configuration as that shown in FIG. 2. However, because the process equipment 1 does not often include the input device such as the keyboard of the personal computer, the fault analysis rule editing unit is not provided in the process fault analysis apparatus 20′, but a fault analysis rule editing apparatus 30 is connected to the EES network 3. The fault analysis rule editing apparatus 30 is formed by a personal computer into which the function of the fault analysis rule editing unit is installed. The fault analysis rule editing apparatus 30 can access the fault analysis rule data storage unit 26 through the EES network 3. Therefore, the rule data produced or edited by the fault analysis rule editing apparatus 30 is stored in the fault analysis rule data storage unit 26 of the process fault analysis apparatus 20′ through the EES network 3. The process fault analysis apparatus 20′ determines the process features based on the process data imparted from the process data collecting device 12, and the process fault analysis apparatus 20′ makes the fault judgment according to the rule data stored in the analysis rule data storage unit 26. When the fault is detected, the process fault analysis apparatus 20′ stores the fault process data or outputs the judgment result.

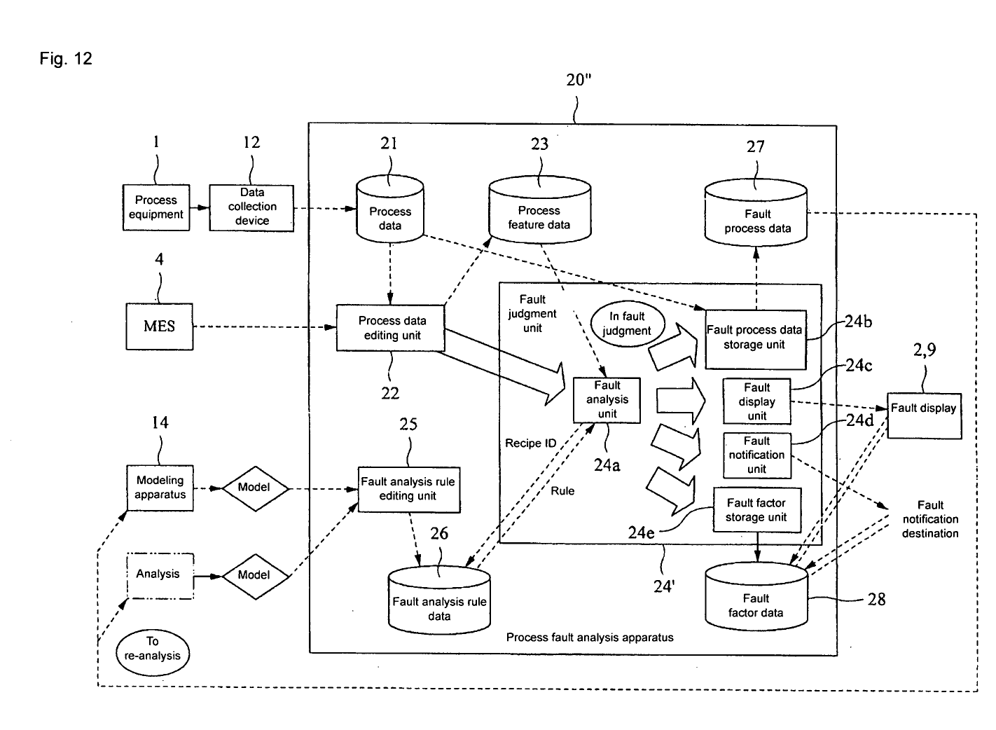

FIG. 12 shows a process fault analysis apparatus according to a second embodiment of the invention. The process fault analysis apparatus 20″ of the second embodiment is formed based on the process fault analysis apparatus 20 of the first embodiment, and the process fault analysis apparatus 20″ has an additional function of storing the fault factor information as the fault factor data when the fault factor information such as the contribution ratio exists as a result of the fault judgment. That is, the process fault analysis apparatus 20″ includes a fault factor data storage unit 28, and a fault factor storage unit 24e is added to the fault judgment unit 24.

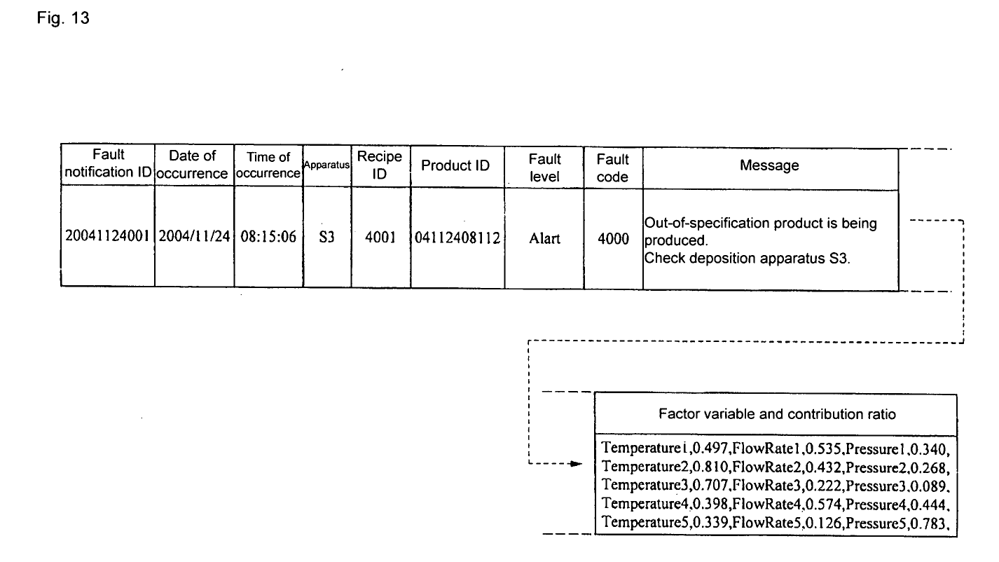

FIG. 13 shows the data structure of the fault factor data stored in the fault factor data storage unit 28. As shown in FIG. 13, the data structure includes a table in which the fault notification ID, the date of occurrence, the time of occurrence, the apparatus number in which the fault is generated, the recipe ID, the product ID, the fault level, the fault code, the message, and the factor variable contribution ratio are associated with one another. The apparatus number, the recipe ID, the product ID, the fault level, the fault code, and the message are generated from the fault notification information stored in the fault analysis rule data storage unit. The date of occurrence and the time of occurrence are generated based on an internal timepiece possessed by the apparatus. The fault analysis unit 24a combines the date of occurrence and a three-digit record number on the date of occurrence to generate the fault notification ID. The example shown in FIG. 13 means the first fault notification generated on Dec. 24, 2004. In the factor variable and the contribution ratio, the top N (including N=n) contribution ratios are extracted from the contribution ratios of the factor variables computed by the fault analysis unit 24a, and a set of the extracted contribution ratio and factor variable is registered in the fault factor data storage unit 28. The fault factor data stored in the fault factor data storage unit 28 can be searched from the pieces of fault display apparatus 2 and 9 or the external devices such as the modeling apparatus 14.

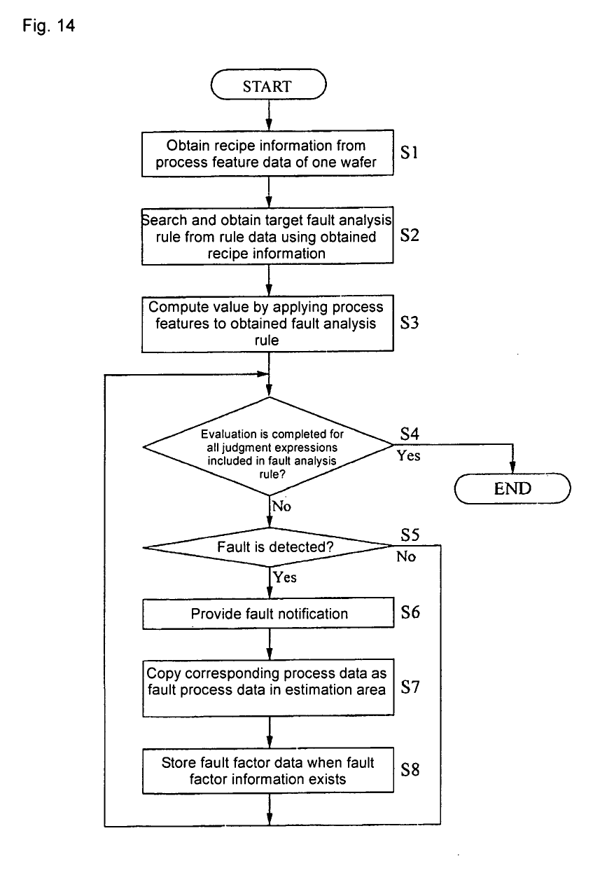

The fault judgment unit 24 of the second embodiment is configured to perform a flow chart shown in FIG. 14. As is clear from comparison with the flow chart shown in FIG. 7, Steps S1 to S7 are similar to those of the first embodiment. After Step S7 is performed, when the fault factor information exists, the fault factor storage unit 24e performs the process of storing the fault factor data in the fault factor data storage unit 28 (S8).

In the above embodiments, the fault display apparatus is formed independently of the process fault analysis apparatus. However, the invention is not limited to the embodiments, but the display device for displaying the fault notification information may be formed in the same apparatus as the process fault analysis apparatus. That is, the fault notification information may be displayed on the display device of the personal computer constituting the process fault analysis apparatus.

What is claimed is:

1. A process fault analysis apparatus in which, in a production system including at least one production apparatus, process data obtained in performing a process is collected at predetermined intervals and a process fault is detected in each unit target product to analyze a fault factor based on the obtained time-series process data,
the process fault analysis apparatus comprising:
a process data storage unit in which the time-series process data is stored;
a process data editing unit which extracts process features from the process data stored in the process data storage unit;
a fault analysis rule data storage unit in which a fault analysis rule is stored, the fault analysis rule being used to perform fault detection and fault factor analysis from the process features;
a fault judgment unit which performs the fault detection and fault factor analysis from the process features using the fault analysis rule; and
a unit which outputs fault notification information when the fault judgment unit judges that the fault is generated,
wherein, in the fault factor analysis, a contribution ratio indicating which process feature has how much effect on the fault is determined, and the process feature having the higher contribution ratio is set at a fault factor.

2. A process fault analysis apparatus according to claim 1, wherein, in the fault detection, it is judged that the fault is generated when a y value determined from the following regression expression by a PLS method exceeds a threshold;
y=b0+b1·x1+b2·x2+ . . . +b(n−1)·x(n−1)+bn·xn
where x1, x2, . . . and xn are variables of the process feature, and b0, b1, b2, . . . and bn are coefficients (b1, b2, . . . and bn are weight of each variable), and
the contribution ratio of the fault factor analysis is set at a value in which a difference between an average value and a measured value multiplied by the coefficient shown below;
b1·(x1−X1), b2·(x2−X2), . . . , and bn·(xn−Xn)
where X1, X2, . . . , and Xn are average values of each variable.

3. A process fault analysis apparatus according to claim 1, further comprising a fault factor data storage unit in which only fault factor data is stored.

4. A process fault analysis apparatus according to claim 1, wherein the fault notification information includes the fault factor data and an ID code for identifying unit target product.

5. A process fault analysis apparatus according to claim 1, wherein the fault notification information includes a predetermined number of contribution ratios in the descending order of the contribution ratio.

6. A fault analysis method comprising:
a process data editing step of extracting process features from time-series process data which is obtained by collecting the process data, obtained in performing a process, at predetermined interval;
a step of performing fault detection and fault factor analysis from the process features using a fault analysis rule; and
a step of providing fault notification information when the fault detection and fault factor analysis judge that the fault is generated,
wherein, in the fault factor analysis, a contribution ratio indicating which process feature has how much effect on the fault is determined, and notification is provided of the process feature having the higher contribution ratio as fault notification information.

7. A program for causing a computer to function as:
a process data editing unit which extracts process features from time-series process data which is obtained by collecting the process data, obtained in performing a process, at predetermined interval;
a fault judgment unit which performs fault detection and fault factor analysis from the process features using a fault analysis rule, the fault analysis rule being stored in a fault analysis rule data storage unit; and
a unit which outputs fault notification information when the fault judgment unit judges that the fault is generated,
wherein, in the fault factor analysis performed by the fault judgment unit, a contribution ratio indicating which process feature has how much effect on the fault is determined, and the process feature having the higher contribution ratio is determined as a fault factor.

8. A computer-readable storage medium in which the program according to claim 7 is stored.
